(19) United States
(12) Patent Application Publication
(10) Pub. No.: US 2014/0286440 A1
(43) Pub. Date: Sep. 25, 2014

(54) QUALITY OF SERVICE MANAGEMENT SYSTEM AND METHOD OF FORWARD ERROR CORRECTION

(71) Applicant: NVIDIA CORPORATION, Santa Clara, CA (US)

(72) Inventor: Atul Apte, Santa Clara, CA (US)

(73) Assignee: Nvidia Corporation, Santa Clara, CA (US)

(21) Appl. No.: 13/847,299

(22) Filed: Mar. 19, 2013

(51) Int. Cl. H04N 19/89

(52) U.S. Cl. CPC H04N 19/00933
USPC 375/240.27

(57) ABSTRACT

A quality of service (QoS) management system and a method of forward error correction (FEC). One embodiment of the QoS management system includes a QoS management server including: (1) an encoder operable to forward error correction (FEC) encode a video stream at a current redundancy level for transmission via a network interface controller (NIC), and (2) a processor operable to receive QoS statistics regarding the video stream via the NIC, employ the QoS statistics to determine a new redundancy level and cause the encoder to FEC encode the video stream at the new redundancy level.

### TECHNICAL FIELD

This application is directed, in general, to cloud gaming and, more specifically, to quality of service in the context of cloud gaming.

### BACKGROUND

The utility of personal computing was originally focused at an enterprise level, putting powerful tools on the desktops of researchers, engineers, analysts and typists. That utility has evolved from mere number-crunching and word processing to highly programmable, interactive workpieces capable of production level and real-time graphics rendering for incredibly detailed computer aided design, drafting and visualization. Personal computing has more recently evolved into a key role as a media and gaming outlet, fueled by the development of mobile computing. Personal computing is no longer resigned to the world's desktops, or even laptops. Robust networks and the miniaturization of computing power have enabled mobile devices, such as cellular phones and tablet computers, to carve large swaths out of the personal computing market. Desktop computers remain the highest performing personal computers available and are suitable for traditional businesses, individuals and garners. However, as the utility of personal computing shifts from pure productivity to envelope media dissemination and gaming, and, more importantly, as media streaming and gaming form the leading edge of personal computing technology, a dichotomy develops between the processing demands for “everyday” computing and those for high-end gaming, or, more generally, for high-end graphics rendering.

The processing demands for high-end graphics rendering drive development of specialized hardware, such as graphics processing units (GPUs) and graphics processing systems (graphics cards). For many users, high-end graphics hardware would constitute a gross under-utilization of processing power. The rendering bandwidth of high-end graphics hardware is simply lost on traditional productivity applications and media streaming. Cloud graphics processing is a centralization of graphics rendering resources aimed at overcoming the developing misallocation.

In cloud architectures, similar to conventional media streaming, graphics content is stored, retrieved and rendered on a server where it is then encoded, packetized and transmitted over a network to a client as a video stream (often including audio). The client simply decodes the video stream and displays the content. High-end graphics hardware is thereby obviated on the client end, which requires only the ability to play video. Graphics processing servers centralize high-end graphics hardware, enabling the pooling of graphics rendering resources where they can be allocated appropriately upon demand. Furthermore, cloud architectures pool storage, security and maintenance resources, which provide users easier access to more up-to-date content than can be had on traditional personal computers.

Perhaps the most compelling aspect of cloud architectures is the inherent cross-platform compatibility. The corollary to centralizing graphics processing is offloading large complex rendering tasks from client platforms. Graphics rendering is often carried out on specialized hardware executing proprietary procedures that are optimized for specific platforms running specific operating systems. Cloud architectures need only a thin-client application that can be easily portable to a variety of client platforms. This flexibility on the client side lends itself to content and service providers who can now reach the complete spectrum of personal computing consumers operating under a variety of hardware and network conditions.

### SUMMARY

One aspect provides a quality of service (QoS) management server, including: (1) an encoder operable to forward error correction (FEC) encode a video stream at a current redundancy level for transmission via a network interface controller (NIC), and (2) a processor operable to receive QoS statistics regarding the video stream via the NIC, employ the QoS statistics to determine a new redundancy level and cause the encoder to FEC encode the video stream at the new redundancy level.

Another aspect provides a QoS enabled client, including: (1) a NIC configured to receive source packets and repair packets of a FEC encoded video stream encoded based on a redundancy level derived from previously transmitted QoS statistics, (2) a processor operable to decode the FEC encoded video stream and collect further QoS statistics for dissemination.

Yet another aspect provides method of FEC, including: (1) receiving QoS statistics indicative of conditions of a network between a server and a client, and (2) determining a redundancy level for FEC encoding a source video stream based on the QoS statistics and transmitting an encoded video stream over the network toward a client for receipt, decoding and display.

### BRIEF DESCRIPTION

Reference is now made to the following descriptions taken in conjunction with the accompanying drawings, in which:

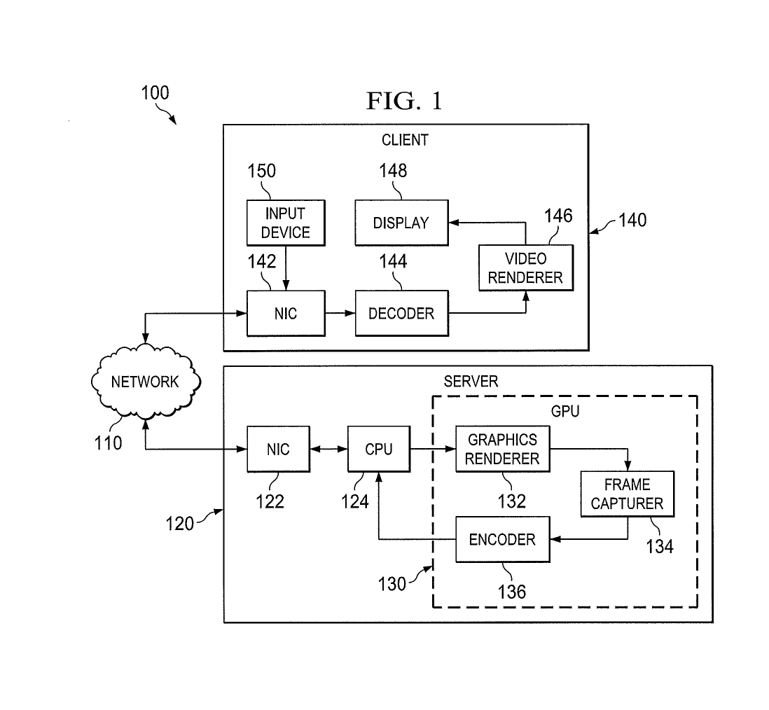

FIG. 1 is a block diagram of a cloud gaming system;

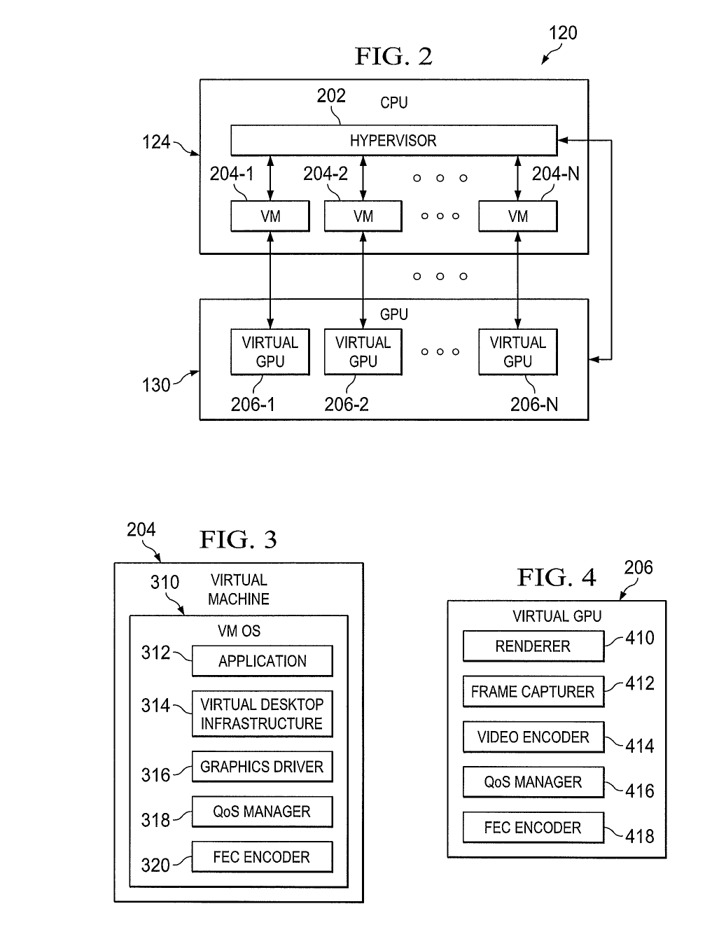

FIG. 2 is a block diagram of a server;

FIG. 3 is a block diagram of one embodiment of a virtual machine;

FIG. 4 is a block diagram of one embodiment of a virtual GPU;

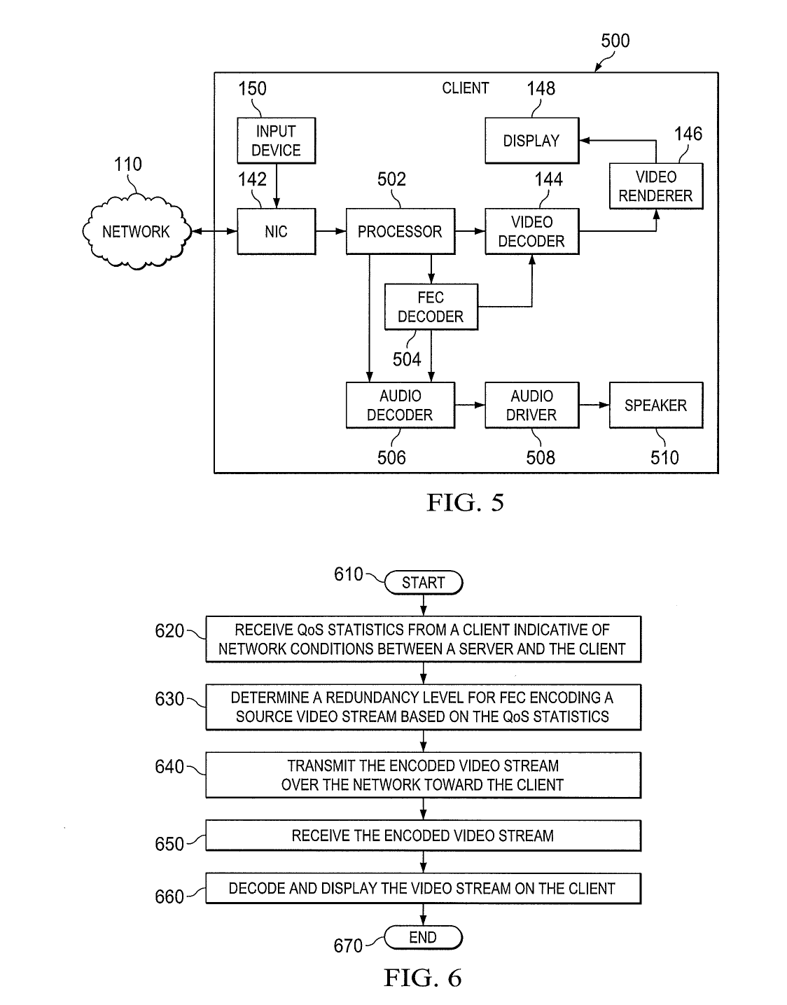

FIG. 5 is a block diagram of one embodiment of a QoS enabled client; and

FIG. 6 is a flow diagram of one embodiment of a method of forward error correction (FEC).

### DETAILED DESCRIPTION

Major limitations of cloud gaming, and cloud graphics processing in general, are latency and the unpredictable network conditions that bring it about. Latency in cloud gaming can be devastating to game play experience. Latency in simple media streaming is less catastrophic because it is overcome pre-encoding the streaming media, buffering the stream on the receiving end, or both. By its nature, cloud gaming employs a significant real-time interactive component in which a user's input closes the loop among the server, client and the client's display. The lag between the user's input and visualizing the resulting effect is considered latency. It is realized herein that pre-encoding or buffering does nothing to address this latency.

Latency is induced by a variety of network conditions, including: network bandwidth constraints and fluctuations, packet loss over the network, increases in packet delay and fluctuations in packet delay from the server to the client, which manifest on the client as jitter. While latency is an important aspect of the game play experience, the apparent fidelity of the video stream to the client is plagued by the same network conditions. Fidelity is a measure of the degree to which a displayed image or video stream corresponds to the ideal. An ideal image mimics reality; its resolution is extremely high, and it has no compression, rendering or transmission artifacts. An ideal video stream is a sequence of ideal images presented with no jitter and at a frame rate so high that it, too, mimics reality. Thus, a higher-resolution, higher-frame-rate, lower-artifacted, lower-jitter video stream has a higher fidelity than one that has lower resolution, a lower frame rate, contains more artifacts or is more jittered.

Latency and fidelity are essentially the client's measures of the game play experience. However, from the perspective of the server or a cloud service provider, the combination of latency and fidelity are components of QoS (QoS). A QoS system, often a server, is tasked with managing QoS for its clients. The goal is to ensure an acceptable level of latency and fidelity, the game play experience, is maintained under whatever network conditions arise and for whatever client device subscribes to the service.

The management task involves collecting network data and evaluating the network conditions between the server and client. Traditionally, the client performs that evaluation and dictates back to the server the changes to the video stream it desires. It is realized herein that a better approach is to collect the network data, or “QoS statistics,” on the client and transmit it to the server so the server can evaluate and determine how to improve QoS. Given that the server executes the application, renders, captures, encodes and transmits the video stream to the client, it is realized herein the server is better suited to perform QoS management. It is also realized herein the maintainability of the QoS system is simplified by shifting the task to the server because QoS software and algorithms are centrally located on the server, and the client need only remain compatible, which should include continuing to transmit QoS statistics to the server.

The client is capable of collecting a variety of QoS statistics. One example is packets lost, or packet loss count. The server marks packets with increasing packet numbers. When the client receives packets, it checks the packet numbers and determines how many packets were lost. The packet loss count is accumulated until QoS statistics are ready to be sent to the server. A corollary to the packet loss count is the time interval over which the losses were observed. The time interval is sent with the QoS statistics, to the server, which can calculate a packet loss rate. Meanwhile, the client resets the count and begins accumulating again.

Another example of a QoS statistic is a one-way-delay. When a packet is ready to transmit, the server writes the transmit timestamp in the packet header. When the packet is received by the client, the receipt timestamp is noted. The time difference is the one-way-delay. Since clocks on the server and client are not necessarily synchronized, the one-way-delay value is not the same as the packet transmit time. So, as the client accumulates one-way-delay values for consecutive packets and transmits them to the server, the server calculates one-way-delay deltas between consecutive packets. The deltas give the server an indication of changes in latency.

Yet another example of a QoS statistic is a frame number. Frame numbers are embedded in each frame of video. When the client sends statistics to the server, it includes the frame number of the frame being processed by the client at that time. From this, the server can determine the speed at which the client is able to process the video stream, which is to say, the speed at which the client receives, unpacks, decodes and renders for display.

QoS statistics are sent periodically to the server for use in QoS determinations. It is realized herein the frequency at which the client sends QoS statistics is itself an avenue of tuning QoS to that client. Another example of a QoS setting, realized herein, is forward error correction (FEC), or more specifically, the level of redundancy employed in FEC encoding. FEC encoding can be applied across all packets corresponding to a single frame of video. FEC techniques rely on the transmission of redundant information from which lost data packets can be recovered. In (n,k) coding, for instance, k source packets are encoded into n encoded packets, or “output packets.” The amount of redundancy is n−k. Increasing the amount of redundancy in the FEC scheme makes it more capable of error correction, but requires more bandwidth and can exacerbate already congested networks. Furthermore, packet losses tend to be high under degraded network conditions and cloud graphics rendering QoS is very sensitive to such losses. For these reasons, it is important to accurately ascertain network conditions and react cautiously when determining the level of redundancy for FEC encoding. It is realized herein, given QoS statistics reported to the server, FEC encoding can be sufficiently managed from the server via a configurable redundancy level. Additionally, the size of the FEC group, or the “k” value, is also available to tune QoS. Generally, as packet losses go up, so should redundancy, unless QoS statistics indicate a network bandwidth shortfall, or “congestion.” In that case, to avoid continued packet loss, aspects of fidelity may be relieved to free up bandwidth, whether it be lower bit rate, frame rate or resolution, or otherwise accept an increase in latency.

Additionally, it is realized herein that a variety of avenues, or QoS settings, for tuning QoS are possible, including: the streaming bit rate, jitter buffering, frame rate scaling, resolution scaling, minimum and maximum bit rates, minimum and maximum capture frame rates, the frequency of bit rate changes and hysteresis in buffering thresholds.

While many FEC schemes are possible, one popular (n,k) encoding scheme is a Reed-Solomon code, which is very efficient at recovering lost data from received packets. Another useful scheme is the systematic code. In a systematic code, a verbatim copy of the source data is contained in the encoded data. This means that if none of the original source packets are lost in transmission, none of the redundant, or “repair,” packets are needed. Furthermore, FEC decoding is not even necessary to recover the source frame of video.

It is realized herein that in addition to the source and repair data, transmitted packets should be loaded with information (in a packet header) regarding the FEC encoding. One helpful piece of information realized herein is the FEC group identification, which allows a client to assemble all the packets necessary for a single frame of video. Other helpful pieces of information, also realized herein, are the number of source packets in a FEC group and packet identification numbers. In a systematic code, each packet is assigned an identification number that effectively identifies a packet as either a source packet or a repair packet by comparing it to the number of source packets in the FEC group. It is further realized herein this information allows for a determination of whether sufficient source packets have been received to bypass FEC decoding.

Before describing various embodiments of the QoS system or method introduced herein, a cloud gaming environment within which the system or method may be embodied or carried out will be described.

FIG. 1 is a block diagram of a cloud gaming system 100. Cloud gaming system 100 includes a network 110 through which a server 120 and a client 140 communicate. Server 120 represents the central repository of gaming content, processing and rendering resources. Client 140 is a consumer of that content and those resources. Server 120 is freely scalable and has the capacity to provide that content and those services to many clients simultaneously by leveraging parallel and apportioned processing and rendering resources. The scalability of server 120 is limited by the capacity of network 110 in that above some threshold of number of clients, scarcity of network bandwidth requires that service to all clients degrade on average.

Server 120 includes a network interface card (NIC) 122, a central processing unit (CPU) 124 and a GPU 130. Upon request from Client 140, graphics content is recalled from memory via an application executing on CPU 124. As is convention for graphics applications, games for instance, CPU 124 reserves itself for carrying out high-level operations, such as determining position, motion and collision of objects in a given scene. From these high level operations, CPU 124 generates rendering commands that, when combined with the scene data, can be carried out by GPU 130. For example, rendering commands and data can define scene geometry, lighting, shading, texturing, motion, and camera parameters for a scene.

GPU 130 includes a graphics renderer 132, a frame capturer 134 and an encoder 136. Graphics renderer 132 executes rendering procedures according to the rendering commands generated by CPU 124, yielding a stream of frames of video for the scene. Those raw video frames are captured by frame capturer 134 and encoded by encoder 136. Encoder 134 formats the raw video stream for transmission, possibly employing a video compression algorithm such as the H.264 standard arrived at by the International Telecommunication Union Telecommunication Standardization Sector (ITU-T) or the MPEG-4 Advanced Video Coding (AVC) standard from the International Organization for Standardization/International Electrotechnical Commission (ISO/IEC). Alternatively, the video stream may be encoded into Windows Media Video® (WMV) format, VP8 format, or any other video encoding format.

CPU 124 prepares the encoded video stream for transmission, which is passed along to NIC 122. NIC 122 includes circuitry necessary for communicating over network 110 via a networking protocol such as Ethernet, Wi-Fi or Internet Protocol (IP). NIC 122 provides the physical layer and the basis for the software layer of server 120's network interface.

Client 140 receives the transmitted video stream for display. Client 140 can be a variety of personal computing devices, including: a desktop or laptop personal computer, a tablet, a smart phone or a television. Client 140 includes a NIC 142, a decoder 144, a video renderer 146, a display 148 and an input device 150. NIC 142, similar to NIC 122, includes circuitry necessary for communicating over network 110 and provides the physical layer and the basis for the software layer of client 140's network interface. The transmitted video stream is received by client 140 through NIC 142. Client 140 can employ NIC 142 to collect QoS statistics based on the received video stream, including packet loss and one-way-delay.

The video stream is then decoded by decoder 144. Decoder 144 should match encoder 136, in that each should employ the same formatting or compression scheme. For instance, if encoder 136 employs the ITU-T H.264 standard, so should decoder 144. Decoding may be carried out by either a client CPU or a client GPU, depending on the physical client device. Once decoded, all that remains in the video stream are the raw rendered frames. The rendered frames a processed by a basic video renderer 146, as is done for any other streaming media. The rendered video can then be displayed on display 148.

An aspect of cloud gaming that is distinct from basic media streaming is that gaming requires real-time interactive streaming. Not only must graphics be rendered, captured and encoded on server 120 and routed over network 110 to client 140 for decoding and display, but user inputs to client 140 via input device 150 must also be relayed over network 110 back server 120 and processed within the graphics application executing on CPU 124. This real-time interactive component of cloud gaming limits the capacity of cloud gaming systems to “hide” latency.

Client 140 periodically sends QoS statistics back to Server 120. When the QoS statistics are ready to be sent, Client 140 includes the frame number of the frame of video being rendered by video renderer 146. The frame number is useful for server 120 to determine how well network 110 and client 140 are handling the video stream transmitted from server 120. Server 120 can then use the QoS statistics to determine what actions in GPU 130 can be taken to improve QoS. Actions available to GPU 130 include: adjusting the resolution at which graphics renderer 132 renders, adjusting the capture frame rate at which frame capturer 134 operates and adjusting the bit rate at which encoder 136 encodes.

FIG. 2 is a block diagram of server 120 of FIG. 1. This aspect of server 120 illustrates the capacity of server 120 to support multiple simultaneous clients. In FIG. 2, CPU 124 and GPU 130 of FIG. 1 are shown. CPU 124 includes a hypervisor 202 and multiple virtual machines (VMs), VM 204-1 through VM 204-N. Likewise, GPU 130 includes multiple virtual GPUs, virtual GPU 206-1 through virtual GPU 206-N. In FIG. 2, server 120 illustrates how N clients are supported. The actual number of clients supported is a function of the number of users ascribing to the cloud gaming service at a particular time. Each of VM 204-1 through VM 204-N is dedicated to a single client desiring to run a respective gaming application. Each of VM 204-1 through VM 204-N executes the respective gaming application and generates rendering commands for GPU 130. Hypervisor 202 manages the execution of the respective gaming application and the resources of GPU 130 such that the numerous users share GPU 130. Each of VM 204-1 through VM 204-N respectively correlates to virtual GPU 206-1 through virtual GPU 206-N. Each of the virtual GPU 206-1 through virtual GPU 206-N receives its respective rendering commands and renders a respective scene. Each of virtual GPU 206-1 through virtual GPU 206-N then captures and encodes the raw video frames. The encoded video is then streamed to the respective clients for decoding and display.

Having described a cloud gaming environment in which the QoS system and method introduced herein may be embodied or carried out, various embodiments of the system and method will be described.

FIG. 3 is a block diagram of virtual machine (VM) 204 of FIG. 2. VM 204 includes a VM operating system (OS) 310 within which an application 312, a virtual desktop infrastructure (VDI) 314, a graphics driver 316, a QoS manager 318, and an FEC encoder 320 operate. VM OS 310 can be any operating system on which available games are hosted. Popular VM OS 310 options include: Windows®, iOS®, Android®, Linux and many others. Within VM OS 310, application 312 executes as any traditional graphics application would on a simple personal computer. The distinction is that VM 204 is operating on a CPU in a server system (the cloud), such as server 120 of FIG. 1 and FIG. 2. VDI 314 provides the foundation for separating the execution of application 312 from the physical client desiring to gain access. VDI 314 allows the client to establish a connection to the server hosting VM 204. VDI 314 also allows inputs received by the client, including through a keyboard, mouse, joystick, hand-held controller, or touchscreens, to be routed to the server, and outputs, including video and audio, to be routed to the client. Graphics driver 316 is the interface through which application 312 can generate rendering commands that are ultimately carried out by a GPU, such as GPU 130 of FIG. 1 and FIG. 2 or virtual GPUs, virtual GPU 206-1 through virtual GPU 206-N.

QoS manager 318 collects QoS statistics transmitted from a particular client, such as client 140, and determines how to configure various QoS settings for that client. The various QoS settings influence the perceived fidelity of the video stream and, consequently, the latency. The various QoS settings generally impact the streaming bit rate, capture frame rate and resolution; however, certain QoS settings are more peripheral, including: the frequency of QoS statistic transmissions, the frequency of bit rate changes and the degree of hysteresis in the various thresholds. Once determined, QoS manager 318 implements configuration changes by directing the GPU accordingly. Alternatively, the QoS manager tasks can be carried out on the GPU itself, such as GPU 130.

QoS manager 318 also manages FEC settings, including the FEC group size and redundancy level. Packet loss statistics are generally well suited for managing the redundancy level. If packet loss is trending up and network bandwidth is available, an increase in the redundancy level would be warranted. However, if network bandwidth is scarce, an increase in the redundancy level would exacerbate the shortage. Likewise, if network conditions are good and packet loss is low, a reduction in the redundancy level stands to free up some network bandwidth, which can be used for other fidelity improvements, resolution for instance. In the embodiment of FIG. 3, FEC encoder 320 is implemented within virtual machine 204. FEC encoder 320 encodes packets of the rendered video stream that can then be routed to the client via VDI 314. FEC encoding is carried out according to the FEC settings determined by QoS manager 318. Alternatively, FEC encoder 320 can be implemented in the GPU, as is the case in the embodiment of FIG. 4.

FIG. 4 is a block diagram of virtual GPU 206 of FIG. 2. Virtual GPU 206 includes a renderer 410, a framer capturer 412, a video encoder 414, a QoS manager 416 and an FEC encoder 418. Virtual GPU 206 is responsible for carrying out rendering commands for a single virtual machine, such as VM 204 of FIG. 3. Rendering is carried out by renderer 410 and yields raw video frames having a resolution. The raw frames are captured by frame capturer 412 at a capture frame rate and then encoded by video encoder 414. The video encoding can be carried out at various bit rates and can employ a variety of formats, including H.264 or MPEG4 AVC. The inclusion of an encoder in the GPU, and, moreover, in each virtual GPU 206, reduces the latency often introduced by dedicated video encoding hardware or CPU video encoding processes. When FEC encoding is enabled, generally to mitigate degraded network conditions, FEC encoder 418 adds a layer of encoding applied across all packets of a single frame of video. FEC allows for more reliable reconstruction of the single frame of video on the client.

Similar to QoS manager 318 of FIG. 3, QoS manager 416 collects QoS statistics and determines how to configure various QoS settings for the client. Unlike the embodiment of FIG. 3, the inclusion of QoS manager 416 within virtual GPU 206 allows more direct control over the elements of each virtual GPU, including renderer 410, frame capturer 412, video encoder 414 and FEC encoder 418. These elements are largely responsible for implementing the various QoS settings arrived at by QoS manager 416, or QoS manager 318 of the embodiment of FIG. 3. Certain other QoS settings originate at the client itself, such as the frequency of QoS statistics transmissions.

FIG. 5 is a block diagram of one embodiment of a QoS enabled client 500. Client 500 is based on client 140 of FIG. 1, but is further configured for FEC. Client 500 is coupled to network 110 via NIC 142 and also includes processor 502, FEC decoder 504, video decoder 144, video renderer 146, display 148 and input device 150. Input device 150, as in FIG. 1, closes the real-time interactive loop. As a user of client 500 views the video stream on display 148, the user responds to the scene via input device 150. Input device 150 can be a variety of devices, including: a mouse, keyboard, joystick, game pad and touchscreen. Input data from input device 150 is packetized and transmitted back to the server via NIC 142 and network 110. Additionally, client 500 includes an audio decoder 506 and an audio driver 508 coupled to a speaker 510.

Packets of an FEC encoded video stream are transmitted by a server over network 110 and arrive at client 500 via NIC 142. FEC encoding often combines a correlated audio signal with the encoded video. This is an efficient scheme for packetizing a correlated audio/video stream. Alternatively, audio data can be encoded and packetized separately. In either case, FEC encoding is useful in loss and error recovery. Processor 502 evaluates the packets to determine how the frames of the video stream should be reconstructed from the received packets. If no FEC decoding is required, processor 502 can direct the video stream to video decoder 144, and the audio stream to audio decoder 506. This can be the case if the FEC encoding is a systematic code and no source packets were lost in the transmission. In that case, the redundant, or repair, packets can be discarded. This evaluation is carried out per frame as long as FEC is employed. Processor 502 identifies received packets according to the FEC group number and packet identification number. The FEC group number tells processor 502 to what frame a particular packet belongs. The packet identification number tells processor 502 whether the particular packet is a source or repair packet (if a systematic code is being used). If some source packets are lost, when processor 502 has a sufficient number of source and repair packets to reconstruct a frame, the packets are sent to FEC decoder 504 for decoding. The packets then go on to video decoder 144 where any video compression or formatting is decoded, such as H.264, yielding raw frames of video that can be rendered and displayed by video renderer 146 and display 148, respectively. The audio data from the packets is sent to audio decoder 506 where any audio compression or formatting is decoded. The decoded audio signal goes to audio driver 508 and ultimately drives speaker 510.

FIG. 6 is a flow diagram of one embodiment of a method of forward error correction. The method begins at a start step 610. In a step 620, QoS statistics are received from a client and are indicative of the network conditions existing between the client and the server. These QoS statistics may include packet loss counts, one-way-delay times and frame numbers. Based on these QoS statistics, a redundancy level for FEC encoding is determined in a step 630. The redundancy level directly impacts the amount of data the server is transmitting over the network to the client. Higher redundancy amounts to an improved likelihood the client will be able to reconstruct individual frames of video from the packets received. Generally, higher packet loss requires greater redundancy to recover. In a step 640, the FEC encoded video stream is transmitted over the network toward the client. The video stream is received by the client in a step 650 as a series of packets. If a sufficient number of the transmitted packets are received at the client, the client will be able to reconstruct the video stream. Depending on the combination of received source packets and received repair packets, the video stream may require FEC decoding in addition to video decoding. In a step 660, the packets are decoded into raw frames of video, which can be rendered and displayed as simply as conventional playback of streaming video. The method then ends in a step 670.

Those skilled in the art to which this application relates will appreciate that other and further additions, deletions, substitutions and modifications may be made to the described embodiments.

What is claimed is:

1. A quality of service (QoS) management server, comprising:
an encoder operable to forward error correction (FEC) encode a video stream at a current redundancy level for transmission via a network interface controller (NIC); and
a processor operable to receive QoS statistics regarding said video stream via said NIC, employ said QoS statistics to determine a new redundancy level and cause said encoder to FEC encode said video stream at said new redundancy level.

2. The QoS management server recited in claim 1 wherein said QoS statistics include a packet loss count, one-way-delay times and frame numbers from a client.

3. The QoS management server recited in claim 1 further comprising a graphics processing unit (GPU) configured to render graphics according to scene data and rendering commands generated by a real-time interactive application.

4. The QoS management server recited in claim 3 wherein said real-time interactive application is a cloud gaming application.

5. The QoS management server recited in claim 1 further comprising a video compression encoder configured to format said video stream for packetizing and FEC encoding.

6. The QoS management server recited in claim 1 wherein said encoder is configured to employ a systematic encoding scheme.

7. The QoS management server recited in claim 1 wherein said encoder is configured to assign a FEC group identification to packets of said video stream and include said FEC group identification in respective headers of said packets.

8. A quality of service (QoS) enabled client, comprising:
a network interface controller (NIC) configured to receive source packets and repair packets of a forward error correction (FEC) encoded video stream encoded based on a redundancy level derived from previously transmitted QoS statistics;
a processor operable to decode said FEC encoded video stream and collect further QoS statistics for dissemination.

9. The QoS enabled client recited in claim 9 wherein said QoS statistics include:
a loss count of said source packets and repair packets over a time interval;
one-way-delay times between consecutive packets of said FEC encoded video stream;
a frame number of a frame being processed by said processor at the time of dissemination.

10. The QoS enabled client recited in claim 8 further comprising a memory configured to store QoS settings including a number of source packets in a FEC group.

11. The QoS enabled client recited in claim 8 wherein said processor is further operable to carry out FEC decoding and video compression decoding.

12. The QoS enabled client recited in claim 8 wherein both said source packets and said repair packets have respective packet headers comprising:
a FEC group identification;
a packet identification; and
a number of source packets in a FEC group.

13. The QoS enabled client recited in claim 12 wherein said processor is further operable to employ said respective packet headers to determine if said source video frame requires FEC decoding.

14. The QoS enabled client recited in claim 13 wherein said processor is further operable to employ said packet identification and said number of source packets in a FEC group to identify said source packets.

15. A method of forward error correction (FEC), comprising:
receiving QoS statistics indicative of conditions of a network between a server and a client; and
determining a redundancy level for FEC encoding a source video stream based on said QoS statistics and transmitting an encoded video stream over said network toward a client for receipt, decoding and display.

16. The method recited in claim 15 wherein said QoS statistics include:
a packet loss count;
one-way-delay times; and
frame numbers.

17. The method recited in claim 15 further comprising:
receiving said encoded video stream;
decoding said encoded video stream; and
displaying a decoded video stream.

18. The method recited in claim 15 further comprising rendering said source video stream based on scene data and rendering commands generated by a real-time interactive graphics application.

19. The method recited in claim 15 wherein said FEC encoding is a systematic encoding.

20. The method recited in claim 19 wherein said FEC encoding is a Reed-Solomon (n,k) encoding.
